(19) United States
(12) Patent Application Publication
(10) Pub. No.: US 2026/0296048 A1
(43) Pub. Date: Oct. 1, 2026

(54) PRINTING SYSTEM AND PRINTING METHOD

(71) Applicant: SEIKO EPSON CORPORATION, Tokyo (JP)

(72) Inventors: Yuki MIYAMOTO, MATSUMOTO-SHI (JP); Hiroki SATO, SHIOJIRI-SHI (JP)

(21) Appl. No.: 19/630,704

(22) Filed: Mar. 27, 2026

(30) Foreign Application Priority Data
Mar. 28, 2025 (JP) 2025-055010

(51) Int. Cl. B41J 2/21; B41J 11/00; G06K 15/02

(52) U.S. Cl. CPC B41J 2/2139; B41J 2/2114; B41J 2/2135; B41J 2/2146; B41J 11/0095; G06K 15/027; G06K 2215/0094; G06K 2215/101

(57) ABSTRACT

A printing system according to an aspect of the present disclosure includes a print head configured to discharge a transparent ink and color ink to a medium, the transparent ink being a colorless, curable liquid, and the color ink being colored liquid; a control unit configured to control discharge of the transparent ink and the color ink, and a sensor. The sensor is configured to optically read and sense a printed result of an adjustment pattern used to adjust a landing position of at least the transparent ink on the medium with the medium moved relative to the printed result along a reading direction. When the adjustment pattern is printed, the control unit is configured to control the print head to form a ruled line having a length component in the reading direction at a position where the transparent ink overlaps with an undercoat layer. The ruled line is configured with multiple structures arranged in the reading direction each having a cross section a surface of which is an arc protruding upward.

The present application is based on, and claims priority from JP Application Serial Number 2025-055010, filed Mar. 28, 2025, the disclosure of which is hereby incorporated by reference herein in its entirety.

### BACKGROUND

### 1. Technical Field

The present disclosure relates to a printing system and a printing method.

### 2. Related Art

JP-A-2005-224989 discloses to readily and accurately detect a test pattern formed with a transparent ink having poor visibility, and describes a technology for discharging the transparent ink to a base material having a surface with minute protruding portions and recessed portions, and sensing information on landing positions of the transparent ink.

JP-A-2005-224989 is an example of the related art.

However, when transparent ink such as ink cured by ultraviolet (UV) light irradiation is used to print an adjustment pattern at a normally used medium used to adjust landing positions of the transparent ink, the accuracy of sensing the adjustment pattern is poor, and it is therefore difficult to accurately acquire the landing positions. The technology described in JP-A-2005-224989 can improve the accuracy of sensing the landing position where the transparent ink lands on the medium, but it is necessary to provide a medium having protruding portions and recessed portions in advance, which increases labor and cost for the adjustment.

It is therefore desired to develop a technology capable of sensing an adjustment pattern used to adjust the landing position of the transparent ink on the medium without extra labor and cost for the adjustment.

### SUMMARY

A printing system according to an aspect of the present disclosure includes a print head configured to discharge transparent ink and color ink to a medium, the transparent ink being a colorless, curable liquid, and the color ink being colored liquid; a control unit configured to control the print head to discharge the transparent ink and the color ink; and a sensor configured to optically read and sense a printed result of an adjustment pattern used to adjust a landing position of at least the transparent ink on the medium while the medium is moved relative to the sensor along a reading direction. When the adjustment pattern is printed on the medium, the control unit is configured to control the print head to form a ruled line having a length component in the reading direction at a position where the transparent ink overlaps with an undercoat layer, and the ruled line is configured with multiple structures arranged in the reading direction each having a cross section a surface of which is an arc protruding upward.

A printing method according to an aspect of the present disclosure is a printing method causing a printing system including a print head configured to discharge transparent ink and color ink to a medium, the transparent ink being a colorless, curable liquid, and the color ink being colored liquid, to print an adjustment pattern used to adjust a landing position of at least the transparent ink on the medium, the printing method including: controlling the print head to form a ruled line having a length component in a first direction at a position where the transparent ink overlaps with an undercoat layer; and optically reading and sensing a printed result of the adjustment pattern while the medium is moved relative to the sensor along a reading direction that is the first direction, and the ruled line is configured with multiple structures arranged in the reading direction each having a cross section a surface of which is an arc protruding upward.

### BRIEF DESCRIPTION OF THE DRAWINGS

FIG. 1 is a diagrammatic view showing an example of the configuration of a printing system according to an embodiment.

FIG. 2 is a diagrammatic view in which an example of recording heads in the printing system is drawn in the form of a planar development.

FIG. 3 is a diagrammatic view showing an example of an adjustment pattern printed in the printing system in FIG. 1.

FIG. 4 is a diagrammatic view showing a cross section of the adjustment pattern shown in FIG. 3 taken along the one-dot chain line.

FIG. 5 is a diagrammatic view showing how the adjustment pattern shown in FIGS. 3 and 4 is sensed with a sensor of the printing system.

FIG. 6 is a diagrammatic view showing an adjustment pattern printed in a printing system according to Comparative Example.

FIG. 7 is a diagrammatic view showing a cross section of the adjustment pattern shown in FIG. 6 taken along the one-dot chain line.

FIG. 8 is a diagrammatic view showing how the adjustment pattern shown in FIGS. 6 and 7 is sensed with a sensor of the printing system according to Comparative Example.

FIG. 9 is a flowchart showing an example of a landing position adjustment method including a printing method used with the printing system shown in FIG. 1.

### DESCRIPTION OF EMBODIMENTS

An embodiment of the present disclosure will be described below with reference to the drawings. Note that the drawings are merely examples for illustrating the embodiment of the present disclosure. Furthermore, all the elements described in the embodiment of the present disclosure are not essential configuration requirements of the present disclosure.

### Embodiment

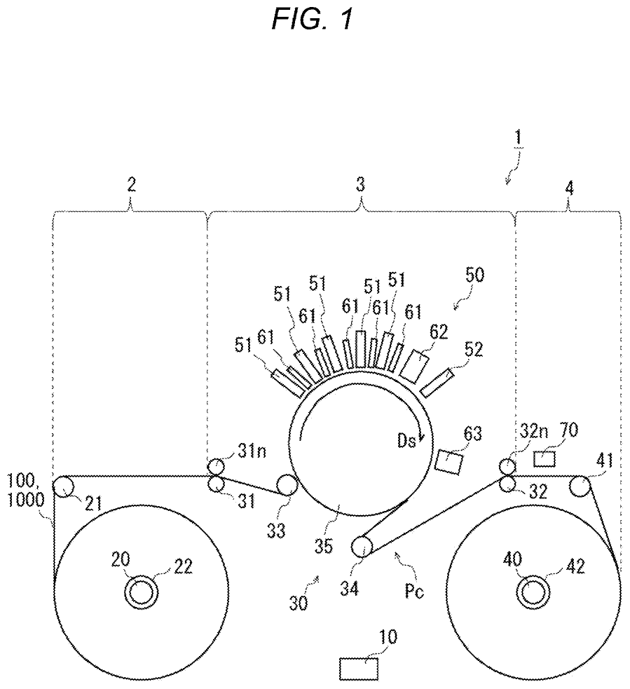

An example of the configuration of a printing system according to the embodiment of the present disclosure will be described with reference to FIG. 1. FIG. 1 is a diagrammatic view showing an example of the configuration of the printing system.

A printing system 1 shown in FIG. 1 includes a control unit 10, a feeding shaft 20, a conveyor 30, a winding shaft 40, a printing unit 50, and a sensor 70. It can be said that the printing system 1 includes a printing apparatus primarily configured with the feeding shaft 20, the conveyor 30, the winding shaft 40, the printing unit 50, and the control unit 10, which controls the elements described above.

The control unit 10 controls the operation of each of the elements of the printing system 1. The control unit 10 controls the printing system 1, and may therefore be referred to as a controller. The control unit 10 may control at least discharge of transparent ink and color ink via a print head, and may further control other portions such as control of the sensor 70.

The control unit 10 may include an arithmetic processing device such as a CPU or a GPU, a working memory, and a storage device that stores a control program, parameters, and other pieces of information. CPU is an abbreviation for a central processing unit. GPU is an abbreviation for a graphics processing unit. The control unit 10 may instead be configured with a system on a chip (SoC). As can be seen from the examples described above, the control unit 10 can be configured to store the control program in an executable manner. Note, however, that the control unit 10 can instead be configured to store the control program as a circuit element such as a field-programmable gate array (FPGA), or can instead be configured with a dedicated circuit. The program described above can include a program that performs control related to ink discharge and irradiation, and sensing of an adjustment pattern or sensing thereof and adjustment of a landing position, as will be described below.

Note that the printing system 1 can include a group of detectors none of which is shown in addition to the sensor 70, that the group of detectors can monitor the situation in the printing system 1, and that the control unit 10 can control the elements of the printing system 1 based on the results of detection performed by the group of detectors.

The feeding shaft 20 feeds a base material 100, which is a medium on which printing is performed. The conveyor 30 conveys the fed base material 100. The printing unit 50 performs printing on the base material 100 conveyed by the conveyor 30. The winding shaft 40 winds printed matter 1000, which is the base material 100 on which printing has been performed. At the time of printing the adjustment pattern, the sensor 70 optically reads the printed matter 1000 before being wound around the winding shaft 40, and senses the adjustment pattern formed on the printed matter 1000.

In the printing system 1, the elongated base material 100 wound in the shape of a roll around the feeding shaft 20 and the winding shaft 40 is stretched along a conveyance path Pc. The base material 100 receives image printing while being conveyed in a conveyance direction Ds at a rotary drum 35 provided between the feeding shaft 20 and the winding shaft 40.

The base material 100 is broadly classified into a paper-based material and a film-based material. Specific examples of the paper-based material include high-quality paper, cast paper, art paper, and coated paper, and examples of the film-based material include synthetic paper, polyethylene terephthalate (PET), and polypropylene (PP). The base material 100 may have any color.

The printing system 1 is divided into three functional regions: a feeding region 2; a processing region 3; and a winding region 4. The feeding region 2 is a region where the base material 100 is fed from the feeding shaft 20. The processing region 3 is a region where liquid is discharged to the base material 100 fed from the feeding region 2. A product formed by the liquid discharged in the processing region 3 may be called an image layer. The winding region 4 is a region where the printed matter 1000, on which the image layer has been formed in the processing region 3, is wound around the winding shaft 40. Note in the following description that out of opposite surfaces of the base material 100, a surface on which the image layer is formed is referred to as a front surface, and the surface opposite the surface on which the image layer is formed is referred to as a rear surface.

The feeding region 2 includes the feeding shaft 20, around which one end portion of the base material 100 is wound, and a driven roller 21, with which the base material 100 drawn from the feeding shaft 20 engages. The feeding shaft 20 supports the base material 100 with one end portion thereof wound around the feeding shaft 20, and the front surface of the base material 100 faces outward. When the feeding shaft 20 rotates clockwise in FIG. 1, the base material 100 wound around the feeding shaft 20 is fed to the processing region 3 via the driven roller 21.

The driven roller 21 is in contact with the base material 100 and is driven to rotate in the conveyance direction Ds of the base material 100 with the aid of a frictional force between the driven roller 21 and the conveyed base material 100. The base material 100 is wound around the feeding shaft 20 via a core tube 22, which is attachable to and detachable from the feeding shaft 20. When the base material 100 around the feeding shaft 20 is used up, a new core tube 22 around which the base material 100 is wound in the form of a roll is attached to the feeding shaft 20.

The processing region 3 includes the conveyor 30 and the printing unit 50, which performs printing on the base material 100 conveyed by the conveyor 30. The conveyor 30 is provided with a front driving roller 31, the rotary drum 35, which supports the base material 100 in a cylindrical shape, and a rear driving roller 32. The printing unit 50 is provided with recording heads 51 and 52 and UV irradiators 61, 62, and 63 as the print head.

In the processing region 3, the base material 100 fed from the feeding region 2 is supported by the rotary drum 35, and the recording heads 51 and 52 and the UV irradiators 61, 62, and 63 disposed along the outer circumferential surface of the rotary drum 35 appropriately perform processing on the base material 100. The processing forms the image layer at the base material 100 in the processing region 3.

The front driving roller 31, which conveys the base material 100 toward the rotary drum 35, is disposed at an upstream position in the processing region 3. The rear driving roller 32, which conveys the base material 100 toward the winding shaft 40, is disposed at a downstream position in the processing region 3. The rotary drum 35 supports the base material 100 conveyed from the front driving roller 31 to the rear driving roller 32.

The front driving roller 31 has a cylindrical or columnar shape having an outer circumferential surface with multiple minute protrusions formed by thermal spraying, and the base material 100 fed from the feeding region 2 engages with the front driving roller 31 with the rear surface of the base material 100 facing the outer circumferential surface of the front driving roller 31. The front driving roller 31 then rotates clockwise in FIG. 1 to cause the base material 100 fed from the feeding region 2 to be conveyed downstream along the conveyance path Pc.

A nip roller 31n is disposed so as to face the front driving roller 31. The nip roller 31n is in contact with the front surface of the base material 100 while being urged toward the front driving roller 31, and the base material 100 is sandwiched between the nip roller 31n and the front driving roller 31. A frictional force between the front driving roller 31 and the base material 100 is thus secured, so that the base material 100 can be reliably conveyed by the front driving roller 31.

The rotary drum 35 is a cylindrical drum supported in a rotatable manner, and the base material 100 conveyed from the front driving roller 31 to the rear driving roller 32 engages with the rotary drum 35 with the rear surface of the base material 100 facing the outer circumferential surface of the rotary drum 35. The rotary drum 35 receives a frictional force between the rotary drum 35 and the conveyed base material 100 while supporting the base material 100 via the rear surface thereof, and is driven to rotate in the conveyance direction Ds of the base material 100.

The processing region 3 is provided with driven rollers 33 and 34, which are disposed on opposite sides, in the conveyance direction Ds, of the region where the base material 100 engages with the rotary drum 35 and change the traveling direction of the base material 100.

The driven roller 33, which is disposed between the front driving roller 31 and the rotary drum 35 in the conveyance direction Ds and with which the front surface of the base material 100 engages, reverses the traveling direction of the base material 100 toward the rotary drum 35.

The driven roller 34, which is disposed between the rotary drum 35 and the rear driving roller 32 in the conveyance direction Ds and with which the front surface of the base material 100 engages, reverses the traveling direction of the base material 100. Reversing the base material 100 at positions upstream and the downstream of the rotary drum 35 in the conveyance direction Ds allows the base material 100 to securely engage with the rotary drum 35 for a long distance.

The rear driving roller 32 has a cylindrical or columnar shape having an outer circumferential surface with multiple minute protrusions formed by thermal spraying, and the base material 100 conveyed from the rotary drum 35 via the driven roller 34 engages with the rear driving roller 32 with the rear surface of the base material 100 facing the outer circumferential surface of the rear driving roller 32. The rear driving roller 32 rotates clockwise in FIG. 1 to convey the base material 100 to the winding region 4. A nip roller 32n is disposed so as to face the rear driving roller 32.

The nip roller 32n is in contact with the front surface of the base material 100 while being urged toward the rear driving roller 32, and the base material 100 is sandwiched between the nip roller 32n and the rear driving roller 32. A frictional force between the rear driving roller 32 and the base material 100 is thus secured, so that the base material 100 can be reliably conveyed by the rear driving roller 32.

The base material 100 conveyed from the front driving roller 31 to the rear driving roller 32 is thus supported by the outer circumferential surface of the rotary drum 35. Thereafter, in the processing region 3, multiple recording heads 51 corresponding to different colors are provided to print a color image at the front surface of the base material 100 supported by the rotary drum 35. FIG. 1 shows a case where five recording heads 51 are arranged in the conveyance direction Ds, but the number of the recording heads 51 is not limited to five, and two or more recording heads 51 for any color such as black may be provided.

The recording heads 51 each face the front surface of the base material 100 having engaged with the rotary drum 35 with slight clearance between the recording head 51 and the front surface of the base material 100, and discharge corresponding color ink in accordance with an inkjet method onto the base material 100 via a nozzle provided at the recording head 51. The printing system 1 uses, as the ink, ultraviolet curable ink that cures when irradiated with ultraviolet light, and forms the image layer on the base material 100. The ultraviolet curable ink is hereinafter also referred to as UV ink.

Note that the UV ink is a type of photocurable ink, contains an ultraviolet curable resin, and cures when a photopolymerization reaction occurs in the ultraviolet curable resin irradiated with ultraviolet light. The ink used in the printing system 1 is, however, not limited to UV ink, and may be liquid that changes in response to active energy irradiation other than ultraviolet light, such as light having another wavelength band or an electron beam. That is, the printing system 1 can also be configured as a printing system of another type that discharges such liquid onto a medium, cures the liquid with the aid of active energy irradiation, and fixes the liquid to the medium.

The processing region 3 is provided with the UV irradiators 61 and 62 to cure the ink and fix the cured ink to the base material 100. The ink is cured in separate two stages, temporary curing and final curing. The UV irradiators 61 for temporary curing are disposed between the multiple recording heads 51. The UV irradiators 61 irradiate ultraviolet light having a weak irradiation intensity to temporarily cure the ink in a way that the speed at which the ink spreads over and wets the base material 100 is sufficiently slow as compared with the speed in a case where no ultraviolet light is irradiated. Occurrence of color mixture, for example, a situation in which multiple types of color ink having different colors mix with each other, is thus prevented. The ink may, however, be cured at once, or in separate three or more stages. In addition, for example, a downstream UV irradiator 61, which cures white ink that is discharged by a large amount as an undercoat, may be used to perform the final curing.

The UV irradiator 62 for the final curing is provided downstream of the multiple recording heads 51 in the conveyance direction Ds. The UV irradiator 62 irradiates ultraviolet light more intensely than the ultraviolet light irradiated by the UV irradiators 61 to cure the ink to the extent that the ink stops spreading over and wetting the base material 100. A color image formed by the multiple recording heads 51 is cured by the UV irradiator 62 and fixed to the base material 100.

The recording head 52 is provided downstream of the UV irradiator 62 in the conveyance direction Ds. The recording head 52 faces the front surface of the base material 100 having engaged with the rotary drum 35 with slight clearance between the recording head 52 and the front surface of the base material 100, and discharges UV ink containing no coloring material in accordance with an inkjet method onto the base material 100 via a nozzle provided at the recording head 52. The UV ink containing no coloring material is also hereinafter referred to as transparent ink. That is, the transparent ink is further discharged to the image layer formed by the recording heads 51.

The UV irradiator 63 is provided downstream of the recording head 52 in the conveyance direction Ds. The UV irradiator 63 irradiates ultraviolet light more intensely than the ultraviolet light irradiated by the UV irradiators 61 to perform the final curing of the transparent ink discharged by the recording head 52. The transparent ink can thus be fixed to the front surface of the base material 100.

As described above, the printing system 1 includes the print head including the recording heads 51 and 52 and the UV irradiators 61 to 63 as the printing unit 50. The recording heads 51 are each an example of a recording head capable of discharging color ink, which is a colored and curable liquid, to the base material 100. The recording head 52 is an example of a recording head capable of discharging transparent ink, which is a colorless and curable liquid, to the base material 100. Note that the recording heads 51 and 52 themselves may each be referred to as a print head.

As described above, in the processing region 3, the ink is appropriately discharged to and cured at the base material 100 that engages with the outer circumference of the rotary drum 35. The base material 100 with the cured ink, that is, the printed matter 1000 is conveyed to the winding region 4 by the rear driving roller 32.

In addition to the winding shaft 40, around which another end portion of the base material 100 has been wound, the winding region 4 includes a driven roller 41, which is disposed between the winding shaft 40 and the rear driving roller 32 and with which the base material 100 engages with the rear surface of the base material 100 facing the outer circumferential surface of the driven roller 41. The winding shaft 40 supports the base material 100 with the other end portion thereof wound around the winding shaft 40, and the front surface of the base material 100 faces outward.

That is, when the winding shaft 40 rotates clockwise in FIG. 1, the base material 100 conveyed from the rear driving roller 32 is wound around the winding shaft 40 via the driven roller 41. The base material 100 is wound around the winding shaft 40 via a core tube 42, which is attachable to and detachable from the winding shaft 40. Therefore, when the winding shaft 40 is full of the base material 100 wound therearound, the base material 100 can be detached along with the core tube 42.

The sensor 70 is provided in the winding region 4 so as to optically read and sense the printed result performed on the front surface of the printed matter 1000 before being wound around the winding shaft 40, as shown in FIG. 1. The printed result includes the printed result of the adjustment pattern. Note that the sensor 70 may be provided in the processing region 3 downstream of the UV irradiator 63.

The sensor 70, in particular, optically reads and senses at least the printed result of the adjustment pattern while the base material 100 is moved relative to the sensor along a reading direction. The adjustment pattern in the description is a pattern used to adjust the landing position where the transparent ink is landed on the base material 100, and may be referred to as a test pattern. The landing position refers to an ink discharge position on the base material 100. When the printing system 1 includes the line-by-line printing unit 50 shown in FIG. 1 by way of example, the reading direction refers to a direction that coincides with the conveyance direction of the base material 100. Note that the conveyance direction of the base material 100, that is, the conveyance direction in which the base material is conveyed may be referred to as a base material conveyance direction.

Note that a computer that is not shown can be communicably connected to the printing system 1 in a wired or wireless manner, and that the computer outputs print data that causes the printing system 1 to print an image to the printing system 1. The printing system 1 having received the print data performs printing on the base material 100.

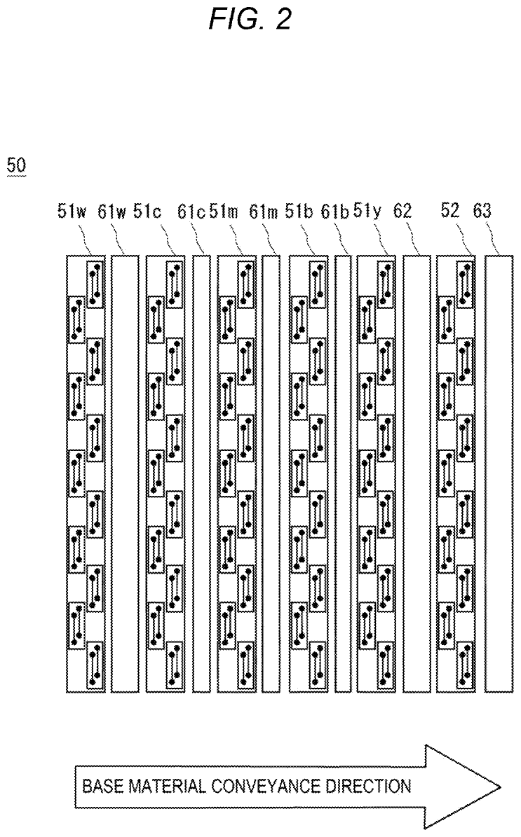

An example of the print head in the printing system 1 will next be described with reference to FIG. 2. FIG. 2 is a diagrammatic view in which an example of the print head, that is, an example of the printing unit 50 is drawn in the form of a planar development.

In the printing unit 50 shown in FIG. 2 by way of example, a white recording head 51w, a UV irradiator 61w for the final or temporary curing of white ink, a cyan recording head 51c, a UV irradiator 61c for the temporary curing, a magenta recording head 51m, a UV irradiator 61m for the temporary curing, a black recording head 51b, a UV irradiator 61b for the temporary curing, a yellow recording head 51y, the UV irradiator 62 for the final curing, the transparent ink recording head 52, and the UV irradiator 63 for the final curing of the transparent ink are disposed from the side upstream in the base material conveyance direction indicated by an arrow.

In each of the recording heads 51w, 51c, 51m, 51b, 51y, and 52, multiple nozzles that discharge ink of a corresponding color are arranged in a direction perpendicular to the base material conveyance direction. These nozzle rows form chip units. Note that FIG. 2 shows a case where the chip units each have two nozzle rows in each of the recording heads 51w, 51c, 51m, 51b, 51y, and 52, and the chip units are arranged in a staggered pattern. The example of the arrangement is, however, merely an arrangement for improving the discharge density, and both the nozzle rows and the chip units may be configured with one row or three or more rows. In addition, FIG. 2 shows a case where white ink, cyan ink, magenta ink, black ink, and yellow ink are used as the multiple types of color ink, and the colors to be employed and the number thereof are not limited thereto. The order of the colors in accordance with which the multiple types of color ink are arranged is not limited to the order shown in FIG. 2.

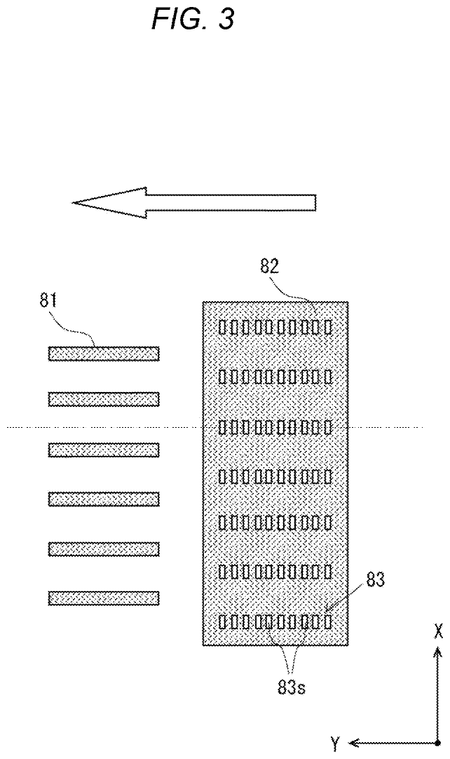

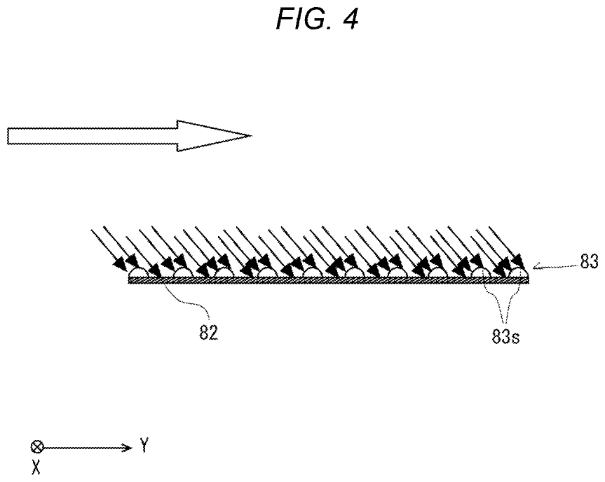

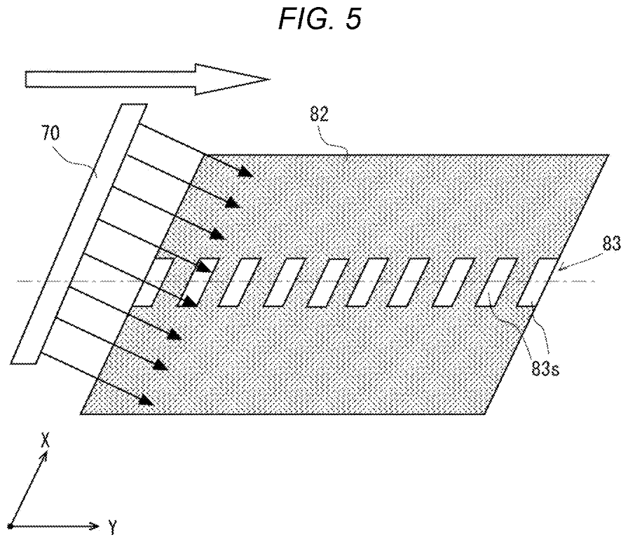

An example of the adjustment pattern to be printed in the printing system 1 and how the sensor 70 senses the adjustment pattern will next be described with reference to FIGS. 3 to 5. FIG. 3 is a diagrammatic view showing an example of the adjustment pattern. FIG. 4 is a diagrammatic view showing a cross section of the adjustment pattern shown in FIG. 3 taken along the one-dot chain line, that is, a cross section taken along a plane containing a reading direction. FIG. 5 is a diagrammatic view showing how the adjustment pattern shown in FIGS. 3 and 4 is sensed by the sensor 70.

To print the adjustment pattern described above at the base material 100, which is a medium, the control unit 10 performs the following control.

The control unit 10 first controls the printing unit 50 to form an undercoat layer 82 with color ink. Note in FIG. 3 that an open arrow indicates the reading direction, in which the sensor 70 performs reading that is performed later, that is, a scan direction, and that the reading direction may be opposite the direction shown in FIG. 3. The color ink may be ink having any color, or may be multiple types of ink having multiple colors. In this process, the control unit 10 may control the printing unit 50 to form ruled lines 81 in parallel to ruled lines formed by the transparent ink, the ruled lines 81 formed for reference with the same color ink at positions separated from landing positions of the transparent ink that will be described later. The ruled lines 81 are used, for example, to acquire the landing positions of transparent ruled lines 83 based on the relative positional relationship between the ruled lines 81 and 83. The intervals at which the ruled lines 81 are arranged are not limited to equal intervals as shown in FIG. 3, and the positions in the X direction where the ruled lines 81 are arranged are not limited to positions between the transparent ruled lines 83.

The control unit 10 then controls the printing unit 50 to form the ruled line 83 having a length component in the reading direction at positions where the transparent ink overlaps with the undercoat layer 82. The thus formed ruled line 83 is referred to as transparent ruled lines 83 in the following description.

Note that the “ruled lines” in the specification of the present application are each intended to be a line segment having a predetermined length or a broken line configured with multiple line segments with a gap therebetween. The multiple line segments and the gap therebetween may be so sized that the combination of the line segments and the gap therebetween can be recognized as a broken line. Furthermore, the sizes of the line segments and the gap therebetween may each not be fixed throughout the broken line, unlike a one-dot chain line.

The “length component” in the specification of the present application is intended to be a component of the length, which corresponds to the long sides of each of the ruled lines described above, out of the width and the length of the ruled line. For example, “having a length component in the reading direction” is intended to mean that the reading direction is substantially parallel to the direction of the long sides of each of the ruled lines. The same applies, of course, to a case where the ruled lines are broken lines, and it is intended that a direction in which the length of the combination of a line segment and a gap that constitute the broken line corresponds to the long sides is substantially parallel to the reading direction.

The transparent ruled lines 83 formed with the transparent ink are broken ruled lines configured with structures 83s, which each have a cross section the surface of which is an arc protruding upward and are repeatedly formed in the reading direction, as shown in FIG. 4 by way of example. Note that the cross section described above refers to a cross section taken along a plane containing the reading direction. Note in FIGS. 4 and 5 that the open arrows indicate the reading direction.

FIG. 4 shows a case where the repeatedly arranged structures 83s are each a structure having a semicircular cross-sectional shape, but the shape is not limited thereto. For example, the repeatedly arranged structures 83s may each be a structure having a cross-sectional shape of an arc of a circle, or a cross-sectional shape of a portion of an arc of a non-circle that approximates an ellipse.

FIG. 4 further shows a case where the transparent ruled lines 83 formed with the transparent ink each have the shape of a broken line having line segments arranged at fixed intervals, the line segments being multiple discharge regions in the reading direction, but not necessarily. For example, the line segments may be arranged at non-fixed intervals each having any size. Furthermore, the transparent ruled lines 83 each do not necessarily have the shape of a broken line. As described in the various examples in the above description, the transparent ruled lines 83 only need to be ruled lines each configured with multiple structures arranged in the reading direction each having a cross section the surface of which is an arc protruding upward.

How the sensor 70 senses the thus formed transparent ruled lines 83 will be described. The sensor 70 can include, for example, a irradiator that irradiates light and a light receiver that receives the light reflected off the ruled lines. The irradiator may cause the light to be incident on the base material 100 on which the transparent ruled lines 83 have been formed at an angle of incidence not corresponding to immediately above, as diagrammatically indicated by multiple arrows in FIGS. 4 and 5. In other words, the light may be incident on the base material 100 on which the transparent ruled lines 83 have been formed at an angle of incidence that is not 0°.

When the transparent ruled lines 83 receive the light irradiated from the sensor 70 as described above, the shape of each of the structures 83s produces a difference in the intensity of the reflected light at the light receiver, so that the intensity of the reflected light at the light receiver is not uniform. The transparent ruled lines 83 can therefore be sensed as ruled lines with the sensor 70. A specific reason for this is that when the light is incident on the base material 100 on which the transparent ruled lines 83 have been formed at an angle of incidence that is not 0°, the light reflected off the surfaces of the structures 83s and the light passing through the structures 83s and reflected off the undercoat layer produce a difference in the intensity of the reflected light. When the angle of incidence is set to 0° and the light is reflected, the light is hardly reflected off the surfaces of the structures 83s, but the light reflected off the undercoat is received and sensed, so that the sensing accuracy deteriorates.

The transparent ruled lines 83, of course, do not each need to be sensed as the shape of a broken line with the sensor 70, and even when some or all of the transparent ruled lines 83 are each sensed as a straight line, the purpose of functioning the transparent ruled lines 83 as the adjustment pattern can be achieved. In addition, the transparent ruled lines 83 do not necessarily each have a specific thickness, and only need to have a thickness that functions as an adjustment pattern used to adjust the landing positions.

Furthermore, FIG. 4 shows the case where the transparent ruled lines 83 contained in the adjustment pattern are ruled lines configured with the structures 83s arranged in the reading direction, at least some of which adjacent to each other are formed so as to be separate from each other. Note, however, that the transparent ruled lines 83 only need to have repeatedly arranged structures each protruding upward even when all the adjacent structures 83s are eventually linked to each other. Even in the case described above, the sensor 70 can sense some or all of the transparent ruled lines 83 as straight lines.

As can be seen from the above description, according to the present embodiment, the adjustment pattern used to adjust the landing positions of the transparent ink on the base material 100 can be sensed without extra labor and cost for the adjustment, such as preparation of a base material having protruding portions and recessed portions in advance.

FIGS. 3 to 5 have been described with reference to the case where the adjustment pattern contains only the transparent ruled lines 83 in the Y direction, which is difficult to sense in the reading direction, and even when the adjustment pattern further contains transparent ruled lines configured with straight lines in the X direction, the sensor 70 can sense both the transparent ruled lines.

The sensor 70 may be provided as an in-line sensor, that is, in the path along which the base material 100 is conveyed, as shown in FIG. 1 by way of example. In this case, to sense the adjustment pattern, the sensor 70 is, of course, provided at a position where the sensor 70 can detect the printed matter 1000 on which the print head has performed printing. The sensor 70 may, for example, be a line sensor in which a group of sensors are arranged in a direction perpendicular to the conveyance path.

The printing system 1 shown in FIG. 1 by way of example is a system incorporating the print head as a portion of a line-by-line printing apparatus. The print head includes nozzles via which multiple types of color ink are discharged and which are arranged across the width of the print region of the base material 100 in a direction perpendicular to the conveyance direction of the base material 100. As described above, when the printing system 1 includes a line-by-line printing apparatus, the sensor 70 can be disposed in the conveyance path of the base material 100, so that the sensor 70 can perform sensing in a shorter period than in a case where the sensor 70 is otherwise disposed.

In addition, using a dark color as the color of the undercoat layer 82 allows the sensor 70 to readily distinguish a difference between the landing region where the transparent ink lands and the region where the transparent ink does not land from each other and sense the difference, as compared with a case where the color of the undercoat layer 82 is not a dark color, so that transparent ruled lines 83 can be sensed with respect to the undercoat layer 82 with improved accuracy. For example, the color of the undercoat layer 82 may be black.

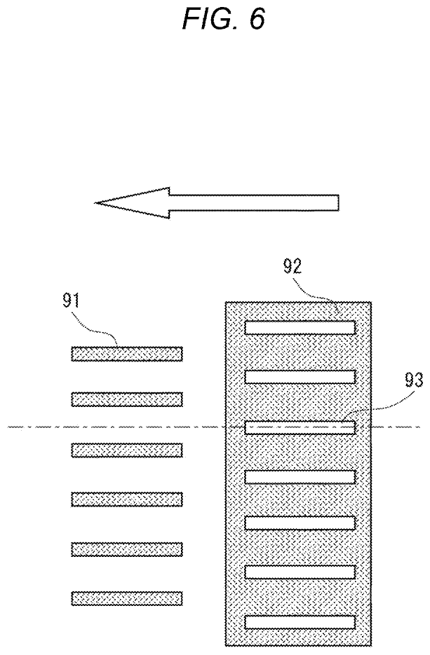

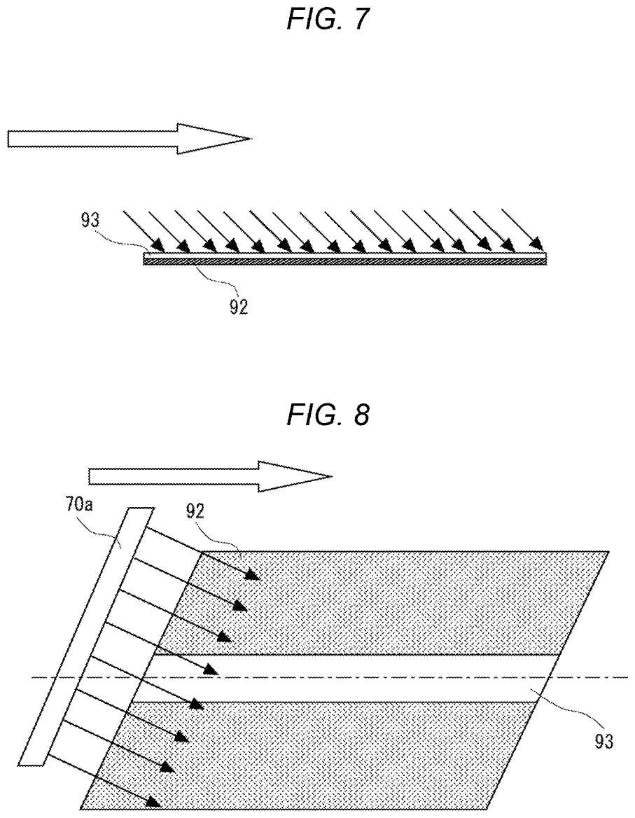

To supplement the advantages of the present embodiment, Comparative Example will next be described with reference to FIGS. 6 to 8. FIG. 6 is a diagrammatic view showing an adjustment pattern printed in a printing system according to Comparative Example. FIG. 7 is a diagrammatic view showing a cross section of the adjustment pattern shown in FIG. 6 taken along the one-dot chain line. FIG. 8 is a diagrammatic view showing how the adjustment pattern shown in FIGS. 6 and 7 is sensed with a sensor of the printing system according to Comparative Example. Note also in FIGS. 6 to 8 that the white arrows refer to the reading direction.

Also in Comparative Example, printing is so performed that an undercoat layer 92 is formed with color ink, as shown in FIG. 6. In this process, the printing may be performed to form ruled lines 91 in parallel to ruled lines formed by the transparent ink, the ruled lines 91 formed for reference with the same color ink at positions separated from landing positions of the transparent ink that will be described later, as in the formation of the ruled lines 81.

In Comparative Example, the printing is so performed that ruled lines 93 configured with straight lines and extending in the reading direction are formed at positions where the transparent ink overlaps with the undercoat layer 92. The thus formed ruled lines 93 are referred to as transparent ruled lines 93 in the following description. Unlike the transparent ruled lines 83, the transparent ruled lines 93 are continuous straight lines. That is, the transparent ruled lines 93 are each a ruled line having a cross section the surface of which is planar in the reading direction, as shown in FIG. 7.

How a sensor 70a, which is similar to the sensor 70, senses the thus formed transparent ruled lines 93 will be described. The irradiator of the sensor 70a causes the light to be incident on a base material on which the transparent ruled lines 93 have been formed at an angle of incidence not corresponding to immediately above, as diagrammatically indicated by multiple arrows in FIGS. 7 and 8. However, unlike the transparent ruled lines 83, even when the transparent ruled lines 93 receive the light irradiated from the sensor 70a, the reflected light received by the light receiver is uniform because the transparent ruled lines 93 have planar surfaces, so that no difference in intensity of the received light occurs in the reading direction. It is therefore difficult for the sensor 70a to sense the transparent ruled lines 93 as ruled lines. As described above, in Comparative Example, when transparent ink such as ink cured by UV light irradiation is used to print an adjustment pattern used to adjust landing positions on the normally used base material 100, the sensing accuracy is poor, and it is therefore difficult to accurately acquire the landing positions.

In contrast, the present embodiment, in which the adjustment pattern contains the transparent ruled lines 83 having a difference in height in the reading direction as described above, allows sensing the adjustment pattern without extra labor and cost for the adjustment, such as preparation of a base material having protruding portions and recessed portions in advance.

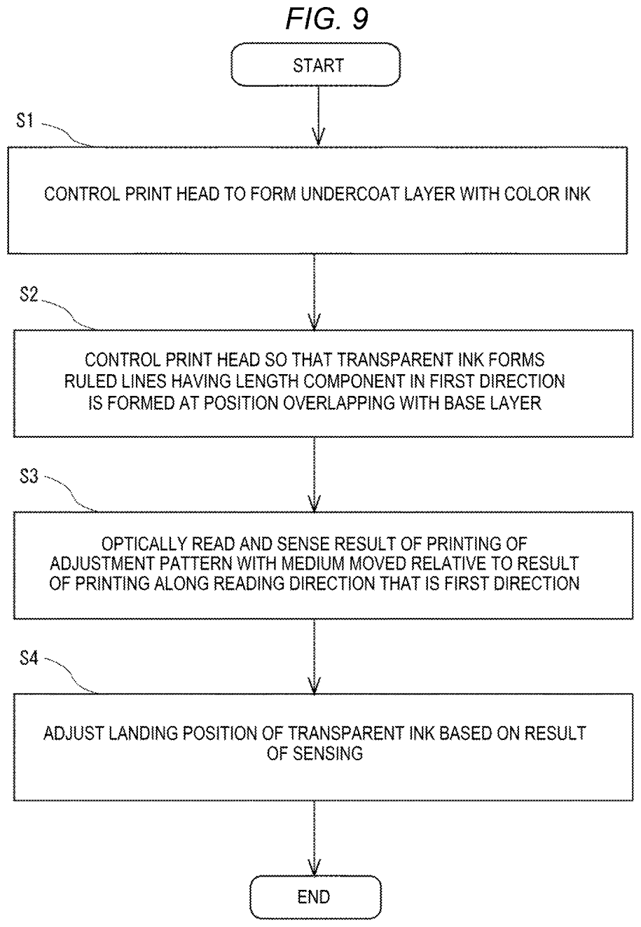

An example of a landing position adjustment method including the printing method used with the printing system 1 will next be briefly described with reference to FIG. 9. FIG. 9 is a flowchart showing an example of the landing position adjustment method including the printing method used with the printing system 1.

In the landing position adjustment method, the printing system 1 carries out a printing process of printing an adjustment pattern used to adjust the landing position of at least the transparent ink on the base material 100, and an adjustment process of adjusting the landing position based on the printed adjustment pattern.

The control unit 10 of the printing system 1 first controls the print head exemplified by the printing unit 50 to form the undercoat layer with color ink (step S1). The control unit 10 then controls the print head so that the transparent ink forms transparent ruled lines having a length component in a first direction at positions where the transparent ink overlaps with the undercoat layer (step S2). The first direction described above refers to the Y direction in FIGS. 3 to 5. As described above, the transparent ruled lines are ruled lines each configured with multiple structures arranged in the reading direction each having a cross section the surface of which is an arc protruding upward, and are exemplified by the transparent ruled lines 83 in FIGS. 3 to 5.

The control unit 10 then controls the sensor 70 to cause the sensor 70 to optically read and sense the printed result of the adjustment pattern on the medium with the medium moved relative to the printed result of the adjustment pattern along a reading direction that is the first direction (step S3).

The control unit 10 finally adjusts the landing position of the transparent ink based on the result of the sensing of the adjustment pattern containing the transparent ruled lines and sensed by the sensor 70 (step S4), and terminates the process.

The adjustment of the landing position in step S4 can be made by using an existing technology. The adjustment will be briefly described. For example, when the detected transparent ruled lines deviate in the X direction, the control unit 10 changes the combination of nozzles via which the ink has been discharged at the corresponding landing position to a combination of adjacent nozzles in accordance with the position where the ink has landed on the transparent ruled lines. For example, when the detected transparent ruled lines deviate in the Y direction, the control unit 10 changes the timing at which the ink landed at the corresponding landing position has been discharged via the nozzles in accordance with the position where the ink has landed on the ruled lines to perform adjustment to eliminate the deviation.

The adjustment described above may be so performed that color reference lines as exemplified by the ruled lines 81 are contained in the adjustment pattern, and the deviation is eliminated based on the deviation of the transparent ruled lines from the reference lines.

Furthermore, printing not only the transparent ruled lines 83 in the Y direction but also the transparent ruled lines in the X direction allows the control unit 10 to adjust the landing positions in the X and Y directions based on the result of sensing both the transparent ruled lines performed by the sensor 70, as described above. As described above, the transparent ruled lines in the X direction shown in FIGS. 3 to 5 do not need to be ruled lines each configured with the repeatedly formed structures 83s, and may be simple straight lines.

### Other Application Examples

Note that the present disclosure is not limited to the embodiment described above and can be changed as appropriate to the extent that the change does not depart from the intent of the present disclosure. For example, the UV irradiator for the final curing only needs to be capable of performing UV irradiation having intensity higher than the intensity of the UV irradiation from the UV irradiator for temporary curing. The curing of the ink is not limited to curing UV ink by irradiating the UV ink with UV light, and thermosetting ink may be heated to cure. The transparent ink has been described as ink containing no coloring material, and the transparent ink may contain a tiny amount of coloring material as long as the ink transmits and reflects light to some extent so as to provide the advantages of the present disclosure.

The printing system including the line-by-line printing apparatus has been described as the present embodiment, and the present disclosure is also applicable to a printing system including a serial printing apparatus. In the case of the serial printing apparatus, the reading direction is perpendicular to the conveyance direction. The present embodiment is widely applicable to apparatuses using the inkjet technology, such as a copier, a facsimile, and a multifunction machine having the functions of a copier and a facsimile. The sensor exemplified by the sensor 70 is not necessarily provided in the path along which the medium is conveyed, and may be provided in another apparatus. That is, in the printing system 1, the printing apparatus and the sensor 70 may be constructed as separate apparatuses. The printing system 1 may be a printing apparatus having one scanning function, and in this case, after the adjustment pattern is printed, the adjustment pattern may be sensed by the user placing the printed matter on a document platen or an automatic document feeder and causing the printing apparatus to scan the printed matter.

The present embodiment has been described with reference to the case where the undercoat layer is formed by color ink that is colored, curable liquid, and the undercoat layer is not necessarily formed by curable ink. This point will be supplemented below. The sensor 70 senses the state of the surface including the structures 83s by causing the light receiver to receive the reflected light originally irradiated from the irradiator and reflected off the structures 83s. In this process, the reflected light is not uniform due to the shape of the structures 83s. Specifically, part of the irradiated light is reflected off the surface of the structures 83s, and part of the irradiated light passes through the structures 83s and is reflected off the undercoat layer. The difference in the path causes a difference in the intensity of the light received by the sensor 70, which generates a portion where the color of the undercoat looks dark and a portion where the color looks light. That is, irrespective of whether the undercoat layer is curable, forming the structures 83s on a colored undercoat allows the sensor 70 to sense the positions of the transparent ruled lines 83. Furthermore, when the medium itself is a colored medium, it is not essential to form the undercoat layer by discharging ink.

The program described above contains a group of commands (or software codes) that cause a computer to perform one or more functions described in the embodiment when the program is read into the computer. The program may be stored on a non-transitory computer-readable medium or a tangible storage medium. The computer-readable medium or the tangible storage medium may include, as an example, but not limited to, a random-access memory (RAM), a read-only memory (ROM), a flash memory, a solid-state drive (SSD), or another memory technology. The computer-readable medium or the tangible storage medium may further include, as an example, but not limited to, a CD-ROM, a digital versatile disc (DVD), a Blu-ray (registered trademark) disk, or another optical disc storage, a magnetic cassette, a magnetic tape, a magnetic disk storage, or another magnetic storage device. The program may be transmitted on a transitory computer-readable medium or a communication medium. The transitory computer-readable medium or the communication medium may include, as an example, but not limited to, a signal that propagates electrically, optically, acoustically, or in other forms.

The present disclosure has been described with reference to the embodiment described above. The present disclosure is not limited only to the configuration in the embodiment described above, and it goes without saying that the present disclosure includes various variations, modifications, and combinations that can be achieved by those skilled in the art within the scope of the disclosure in the claims of the present application.

What is claimed is:

1. A printing system comprising:
a print head configured to discharge transparent ink and color ink to a medium, the transparent ink being a colorless, curable liquid, and the color ink being colored liquid;
a control unit configured to control the print head to discharge the transparent ink and the color ink; and
a sensor configured to optically read and sense a printed result of an adjustment pattern used to adjust a landing position of at least the transparent ink on the medium while the medium is moved relative to the sensor along a reading direction,
wherein when the adjustment pattern is printed on the medium, the control unit is configured to control the print head to form a ruled line having a length component in the reading direction at a position where the transparent ink overlaps with an undercoat layer, and
the ruled line is configured with multiple structures arranged in the reading direction each having a cross section a surface of which is an arc protruding upward.

2. The printing system according to claim 1, wherein
the ruled line is configured with the structures arranged in the reading direction, at least some of which adjacent to each other are formed so as to be separate from each other.

3. The printing system according to claim 1, wherein
the sensor includes a irradiator configured to radiate light and a light receiver configured to receive the light reflected off the ruled line, and
the irradiator is configured to cause the light to be incident on the medium on which the ruled line is formed at an angle of incidence that is not 0°.

4. The printing system according to claim 1, wherein
the sensor is provided in a path along which the medium is conveyed.

5. The printing system according to claim 1, wherein
the undercoat layer has a dark color.

6. The printing system according to claim 5, wherein
the color of the undercoat layer is black.

7. The printing system according to claim 1, wherein
the printing system is a system incorporating the print head as a portion of a line-by-line printing apparatus.

8. A printing method causing a printing system including a print head configured to discharge transparent ink and color ink to a medium, the transparent ink being a colorless, curable liquid, and the color ink being colored liquid, to print an adjustment pattern used to adjust a landing position of at least the transparent ink on the medium, the printing method comprising:
controlling the print head to form a ruled line having a length component in a first direction at a position where the transparent ink overlaps with an undercoat layer; and
optically reading and sensing a printed result of the adjustment pattern while the medium is moved relative to the sensor along a reading direction that is the first direction,
wherein the ruled line is configured with multiple structures arranged in the reading direction each having a cross section a surface of which is an arc protruding upward.
